(19) United States
(12) Patent Application Publication
(10) Pub. No.: US 2026/0032643 A1
(43) Pub. Date: Jan. 29, 2026

(54) MANAGING DOWNLINK (DL) AND UPLINK (UL) OPERATIONS WITHIN A WIRELESS TELECOMMUNICATION SYSTEM

(71) Applicant: DISH Wireless L.L.C., Englewood, CO (US)

(72) Inventor: In-Kyung Kim, Highlands Ranch, CO (US)

(21) Appl. No.: 18/784,588

(22) Filed: Jul. 25, 2024

(51) Int. Cl. H04W 72/02; H04W 24/02; H04W 84/06

(52) U.S. Cl. CPC H04W 72/02; H04W 24/02; H04W 84/06

(57) ABSTRACT

Systems and methods for managing downlink (DL) and uplink (UL) operations in wireless telecommunication systems are disclosed that facilitate the coexistence of narrowband-Internet of Things (NB-IoT) and Fifth Generation (5G) New Radio (NR) operations within the same frequency bands. The system partitions carrier bandwidths (BW) to isolate NB-IoT from 5G NR operations, reducing interference. For DL, a portion of the BW is designated for NB-IoT, while the rest is for 5G NR. For UL, protection frequencies are determined to avoid interference with critical satellite communications, such as NOAA satellites, with blanking applied when satellites are overhead. Two main techniques for managing UL operations are provided: a baseline technique and an operationally efficient technique. The system supports various carrier bandwidths and includes dynamic detection and blanking methods to optimize spectrum use and protect essential frequencies.

### TECHNICAL FIELD

The present disclosure relates to managing operations within a wireless telecommunication system, and specifically managing DL and UL operations within a wireless telecommunication system.

### BRIEF SUMMARY

Described herein are systems and methods for managing downlink (DL) and uplink (UL) operations within a wireless telecommunication system. The techniques described herein help to ensure the efficient coexistence of narrowband-Internet of Things (NB-IoT) and Fifth Generation (5G) New Radio (NR) operations within the same frequency bands. In an example embodiment, the system described herein facilitates optimizing spectrum usage, reduces interference, and protects critical frequencies such as those used by the National Oceanic and Atmospheric Administration (NOAA) satellites.

In current wireless telecommunication systems, a significant challenge is managing the coexistence of different types of operations, such as NB-IoT and 5G NR, within the same frequency bands. These different types of operations have distinct requirements and characteristics. For instance, NB-IoT is designed for low-power, wide-area applications with narrower bandwidth and lower data rates, while 5G NR supports high-speed, high-capacity services such as Enhanced Mobile Broadband (eMBB).

One primary problem is the potential interference between NB-IoT and 5G NR operations when they share the same frequency band. NB-IoT operations, due to their narrower bandwidth, can create high-power density signals that may interfere with adjacent 5G NR operations. This interference can degrade the performance of 5G NR services, leading to potential communication failures.

Moreover, there is a need to protect specific frequencies used by NOAA satellites from uplink transmissions, especially when these satellites are overhead.

In an example embodiment, the system described herein addresses these problems through strategic partitioning and dynamic management of carrier bandwidths. For DL operations, the method involves partitioning a portion of the DL carrier bandwidth allocated to a wireless carrier within a 5G NR DL frequency band specifically for NB-IoT DL operations. NB-IoT operations are confined to this partitioned portion, while other 5G NR DL operations are restricted to the remaining bandwidth. For example, a 25 MHz DL carrier BW might be divided into a 20 MHz segment for general 5G NR DL operations and a 5 MHz segment for NB-IoT DL operations. This segregation ensures that high-power density signals from NB-IoT do not interfere with broader 5G NR operations, allowing both to coexist without mutual interference.

For UL operations, the systems and methods described herein present two main techniques for doing so: a baseline technique and an operationally efficient technique.

The baseline technique optimizes spectrum usage but is location and time dependent. In this technique, each Next Generation Node B (gNB) creates blanking patterns specific to the satellites it sees overhead at a particular time. Each gNB maintains its own set of blanking patterns, which change periodically based on satellite positions. This technique utilizes two blanking frequency sets. The first set is used when no satellite is overhead, allowing NR and NB-IoT to coexist. The second set is used when satellites are overhead and non-blanked portions have enough bandwidth to carry 5G. This pattern is specific to the satellites the gNB needs to protect at that time, allowing NR, NB-IoT, and satellite transmissions to coexist. If there's not enough bandwidth, the entire UL is blanked, allowing only NB-IoT and satellite transmissions.

The operationally efficient technique sacrifices some spectrum efficiency for operational simplicity. This technique uses a single blanking pattern that falls outside the superset of protection frequencies for all satellites, regardless of time and location. This pattern is used when no satellite is overhead for all times and all gNBs. When a satellite is overhead, the gNB shuts off UL transmissions entirely. While this method may waste some spectrum when satellites are overhead, it simplifies operations across the network.

### BRIEF DESCRIPTION OF THE SEVERAL VIEWS OF THE DRAWINGS

FIG. 1 illustrates an example partitioning of a downlink (DL) carrier bandwidth within a wireless telecommunication system to facilitate the coexistence of narrowband-Internet of Things (NB-IoT) and Fifth Generation (5G) New Radio (NR) operations, according to various embodiments described herein.

FIG. 2 illustrates a power spectral density problem solved by the partitioning of the DL carrier bandwidth illustrated in FIG. 1, according to various embodiments described herein.

FIG. 3 illustrates an example partitioning of an uplink (UL) carrier bandwidth within a wireless telecommunication system to facilitate the coexistence of NB-IoT and 5G NR operations when protection of National Oceanic and Atmospheric Administration (NOAA) frequencies is not needed, according to various embodiments described herein.

FIG. 4 illustrates an example partitioning and blanking mechanism of the UL carrier bandwidth of FIG. 3 to facilitate the coexistence of NB-IoT and 5G NR operations at times when protection of certain frequencies, such as NOAA frequencies, is needed, according to various embodiments described herein.

FIG. 5 illustrates a power spectral density problem solved by the partitioning of the UL carrier bandwidth illustrated in FIG. 3 and FIG. 4, according to various embodiments described herein.

FIG. 6 illustrates an example implementation of an NB-IoT specific blanking pattern within the n70 unpaired spectrum, including the allocation and management of UL carrier bandwidths for various carrier configurations (5 MHz, 10 MHz, and 15 MHz) within the 5G NR UL frequency band, according to various embodiments described herein.

FIG. 7 is a flowchart illustrating a method for managing DL operations within a wireless telecommunication system, according to various embodiments described herein.

FIG. 8 is a flowchart illustrating a method for partitioning, for NB-IoT DL operations, a portion of the DL carrier BW useful in the method of FIG. 7, according to various embodiments described herein.

FIG. 9A is a flowchart illustrating a method for managing UL operations within a wireless telecommunication system in an example baseline scheme for managing UL operations when no satellite is overhead, according to various embodiments described herein.

FIG. 9B is a flowchart illustrating a method for managing UL operations within a wireless telecommunication system wherein different options may be utilized depending on whether there is enough BW left available in the 5G NR UL frequency band for 5G NR UL operations if blanking of 5G NR UL transmissions is applied in the determined protection frequencies such as in an example baseline scheme for managing UL operations when one or more satellites are overhead, according to various embodiments described herein.

FIG. 10A is a flowchart illustrating a method for implementing a-preparation stage in determining the banking frequencies for an operationally efficient scheme for managing UL operations, according to various embodiments described herein.

FIG. 10B is a flowchart illustrating a method for managing UL and DL operations within a wireless telecommunication system in an example implementation of the operationally efficient scheme for managing UL operations when no satellite is overhead and applying the blanking pattern determined in method 1000 of FIG. 10A, according to various embodiments described herein.

FIG. 11 is a flowchart illustrating a method for applying blanking of UL transmissions implementing the operationally efficient scheme when the certain satellites are overhead, according to various embodiments described herein.

FIG. 12 shows a system diagram that describes an example implementation of computing system(s) for implementing embodiments described herein.

### DETAILED DESCRIPTION

In the following description, certain specific details are set forth in order to provide a thorough understanding of various disclosed embodiments. However, embodiments may be practiced without one or more of these specific details, or with other methods, components, materials, etc. Well-known structures and methods associated with media content delivery, or repeated corresponding methods, components, materials, etc., have not been shown or described in detail (or have been shown in the Figures, but not described or referenced in detail in the detailed description) to avoid unnecessarily obscuring descriptions of the preferred embodiments. Some individual components and methods familiar to those of ordinary skill in the art are shown in the Figures for various corresponding devices to provide context, but are not referenced or described in detail in the detailed description so as not to obscure the disclosure with details that will be readily apparent to those of ordinary skill in the art having the benefit of the description herein.

Unless the context requires otherwise, throughout the specification and claims which follow, the word “comprise” and variations thereof, such as, “comprises” and “comprising” are to be construed in an open, inclusive sense, for example, “including, but not limited to.”Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

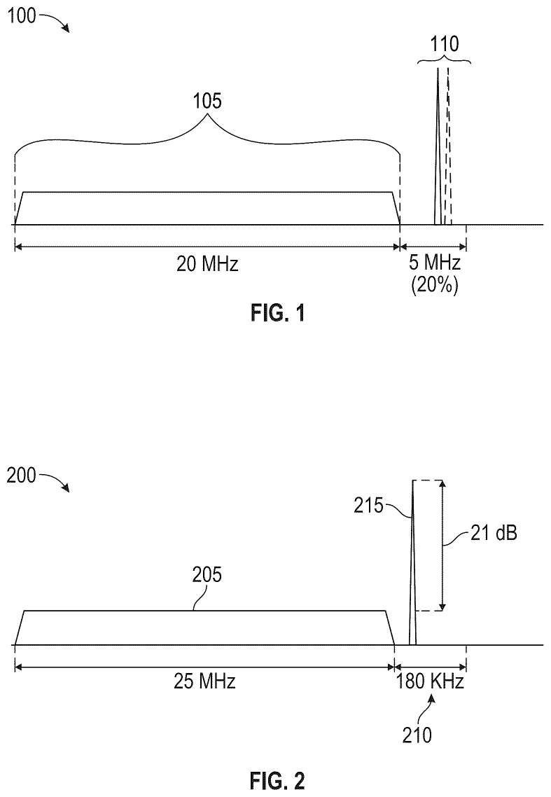

The headings and Abstract of the Disclosure provided herein are for convenience only and do not interpret the scope or meaning of the embodiments. FIG. 1 illustrates an example partitioning of a downlink (DL) carrier bandwidth 100 within a wireless telecommunication system to facilitate the coexistence of narrowband-Internet of Things (NB-IoT) and Fifth Generation (5G) New Radio (NR) operations, according to various embodiments described herein.

The partitioning of DL carrier BW 100 reduces interference between different types of DL operations. In the illustration, a 25 MHz DL carrier BW 100 is allocated to a wireless carrier within a 5G NR DL frequency band, such as the DL frequency band of the 5G NR band n70, which has a frequency range from 1695-1710 MHz (UL) and 1995-2020 MHz (DL), with a UL/DL bandwidth of 15/25 MHz. The DL carrier BW 100 is divided into two portions: a 20 MHz segment 105 designated for wideband 5G NR DL operations and a 5 MHz segment 110 specifically partitioned for NB-IoT DL operations. The 20 MHz portion 105 is reserved for general 5G NR DL operations, including Enhanced Mobile Broadband (eMBB) services.

The 5 MHz segment 110, which constitutes twenty percent of the total DL carrier BW 100, is dedicated to NB-IoT DL operations. Designed for low-power, wide-area (LPWA) applications, NB-IoT requires narrower bandwidth and lower data rates compared to eMBB services. By isolating NB-IoT DL operations to this 5 MHz segment 110, the system ensures reliable communication for IoT devices without interference from other high-speed 5G NR operations.

In an example embodiment, the example partitioning of DL carrier BW 100 illustrated demonstrates a coexistence mechanism where both NB-IoT and other 5G NR DL operations can occur simultaneously within the same overall DL carrier BW but in separate designated portions. This method enables the wireless carrier to manage and optimize spectrum usage effectively, ensuring that both types of operations can coexist without causing mutual interference while also being compliant with 3rd Generation Partnership Project (3GPP) standards. Transmissions for the 5G NR DL operations are confined to the 20 MHz segment 105 designated for wideband 5G NR DL operations and transmissions for the NB-IoT DL operations are confined to the 5 MHz segment 110 specifically partitioned for NB-IoT DL operations. User equipment (UE) supported by the carrier is instructed to perform NB-IoT DL operations only within the 5 MHz partitioned portion and to perform other 5G NR DL operations only within the segregated 20 MHz segment 105. The example partitioning of DL carrier BW 100 provides a representation of how a 25 MHz DL carrier BW is strategically segregated into a 20 MHz segment 105 for general 5G NR DL operations and a 5 MHz segment 110 for NB-IoT DL operations. This mechanism enables efficient coexistence of different types of DL operations, optimizing the use of available spectrum and ensuring reliable communication for both high-speed data and IoT devices within 3GPP standards.

FIG. 2 illustrates a power spectral density problem 200 that is solved by the partitioning of the DL carrier BW illustrated in FIG. 1, according to various embodiments described herein.

Shown is a power spectral density problem 200 that can arise in the absence of proper bandwidth partitioning. The power spectral density problem 200 represents the system experiencing the power spectral density issue. The 25 MHz DL carrier band 205 is intended for 5G NR DL operations. This broad spectrum is essential for high-speed and high-capacity communication. Spike 215 indicates a narrowband transmission over a 180 kHz bandwidth 210, which results in a significant increase in power spectral density by 21 dB. This 21 dB increase in power is due to the high concentration of power within the narrow 180 kHz bandwidth 210 used for NB-IoT DL operations. Such a high-power density being next to the 25 MHz DL band 205 can cause substantial interference with the broader 25 MHz DL band 205 intended for 5G NR DL operations. The interference occurs because the high-power narrowband signal can overwhelm adjacent frequencies within the 5G NR DL carrier band 205, leading to degraded performance and potential communication failures.

The example partitioning mechanism illustrated in FIG. 1 that partitions DL carrier BW 100 solves this interference problem by segregating the DL carrier BW 100 into distinct segments for NB-IoT and 5G NR operations. By allocating a dedicated 5 MHz portion 110 for NB-IoT DL operations, the system ensures that the high-power density signal is confined to this narrow segment. The remaining 20 MHz band 105 is reserved for 5G NR DL operations, free from the interference caused by NB-IoT transmissions. This strategic partitioning effectively mitigates the interference issue by isolating the high-power NB-IoT signals, allowing both types of operations to coexist within the same overall DL carrier BW 100 without detrimental effects on each other. The result is a more efficient and reliable utilization of the available spectrum, supporting both high-capacity 5G NR services and the specific needs of NB-IoT communications.

Also described herein is a mechanism for managing UL carrier BW within a wireless telecommunication system, enabling the coexistence of NB-IoT operations, 5G NR operations and the protection of certain protected frequencies, such as NOAA satellite frequencies. The systems and methods described herein regarding managing UL operations present two main techniques for doing so: a baseline technique and an operationally efficient technique.

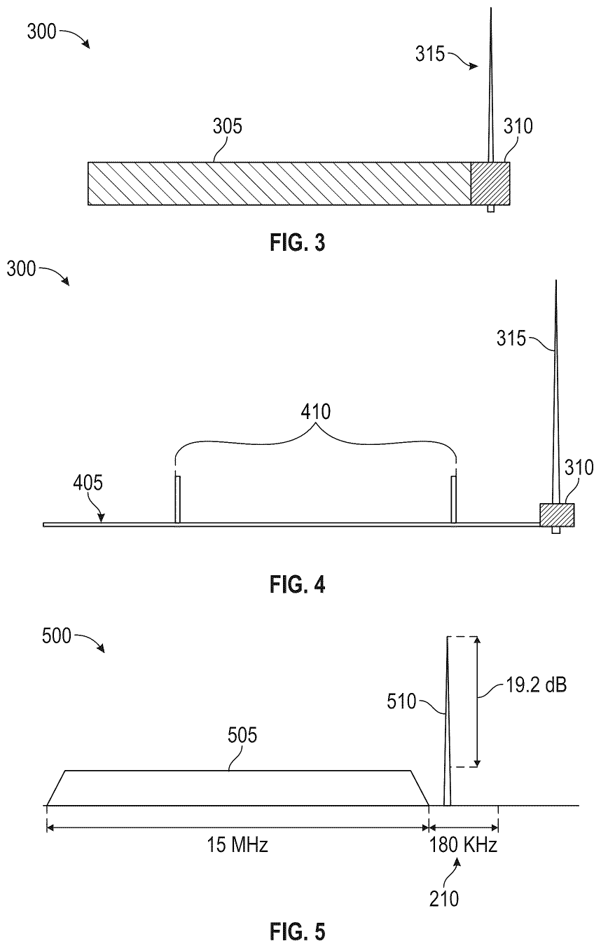

The baseline technique is designed to maximize spectrum usage but requires more complex management due to its time and location dependency. In this technique, each base station (e.g., Next Generation Node B (gNB)) creates blanking patterns specific to the satellites it sees overhead at a particular time. Each gNB maintains its own set of blanking patterns, which change periodically based on satellite positions. The technique utilizes two blanking frequency sets. The first set is used when no satellite is overhead, allowing 5G NR and NB-IoT to coexist. For example, FIG. 3 illustrates an example partitioning of an UL carrier BW 300 within a wireless telecommunication system to facilitate the coexistence of NB-IoT and 5G NR operations at times when protection of certain frequencies, such as NOAA satellite frequencies, is not needed. In an example embodiment, a specific blanking pattern 310 for NB-IoT operations is shown that lies outside the protected NOAA frequencies. In particular, referring to FIG. 3, at times where NOAA protection is not required (e.g., when there is no NOAA satellite over the horizon), only the NB-IoT specific blanking pattern 310 is applied. This pattern allows NB-IoT carriers to transmit 315 within the designated blanking pattern 310 for NB-IoT operations, ensuring that 5G NR operations are protected within the 5G NR UL portion 305 of the UL carrier BW 300 allocated for 5G NR operations. The allocation of these NB-IoT transmissions 315 within a specific segment of the UL carrier BW 300 effectively isolates them from the rest of the spectrum used by other 5G NR operations.

The second set is used when satellites are overhead and non-blanked portions have enough bandwidth to carry 5G NR. The specific blanking pattern includes blanking pattern 310 for NB-IoT operations that lies outside the protected NOAA frequencies, ensuring efficient spectrum usage while safeguarding critical satellite communication frequencies by ensuring that NB-IoT transmissions do not interfere with critical NOAA satellite operations. This pattern is also specific to the satellites the gNB needs to protect at that time, allowing 5G NR, NB-IoT, and satellite transmissions to coexist. This method optimizes spectrum usage but requires each gNB to maintain and update multiple blanking patterns based on its specific location and the satellites overhead at any given time. However, if there's not enough bandwidth in the second set, the entire UL is blanked, allowing only NB-IoT and satellite transmissions. For example, referring to FIG. 4, at times where NOAA protection is needed (e.g., when there is a NOAA satellite over the horizon), the application of full UL blanking 405 is performed. This ensures that NOAA frequencies 410 are entirely protected by not only placing NB-IoT transmissions 315 outside the NOAA frequency range in the NB-IoT specific blanking pattern 310, but also by applying the full UL blanking 405 to the entirety of the 5G NR UL portion 305 of the UL carrier BW 300 shown in FIG. 3 that may overlap with the NOAA frequencies, thereby preventing any interference from 5G NR transmissions. While protecting specific frequencies through the baseline technique may seem like a viable solution, it introduces significant complications. These include dynamic adjustments, overlapping frequencies,, higher operational costs, and regulatory compliance challenges. Instead, more stable and less disruptive methods, such as the operationally efficient technique provide a more reliable and efficient approach to coexistence in the spectrum.

The operationally efficient technique trades some spectrum efficiency for operational simplicity. In this technique, a single blanking pattern 310 is used across all gNBs and all times when no satellite is overhead. This blanking pattern 310 is designed to fall outside the superset of protection frequencies for all satellites, regardless of time and location. When a satellite is overhead, the gNB shuts off 5G NR UL transmissions entirely, thereby applying full UL blanking 405. To maintain service continuity when 5G NR UL transmissions are shut off, the system moves users to other UL frequencies or carriers. While this method may result in some unused spectrum when satellites are overhead, it significantly simplifies network operations by using a consistent blanking pattern across all gNBs and times.

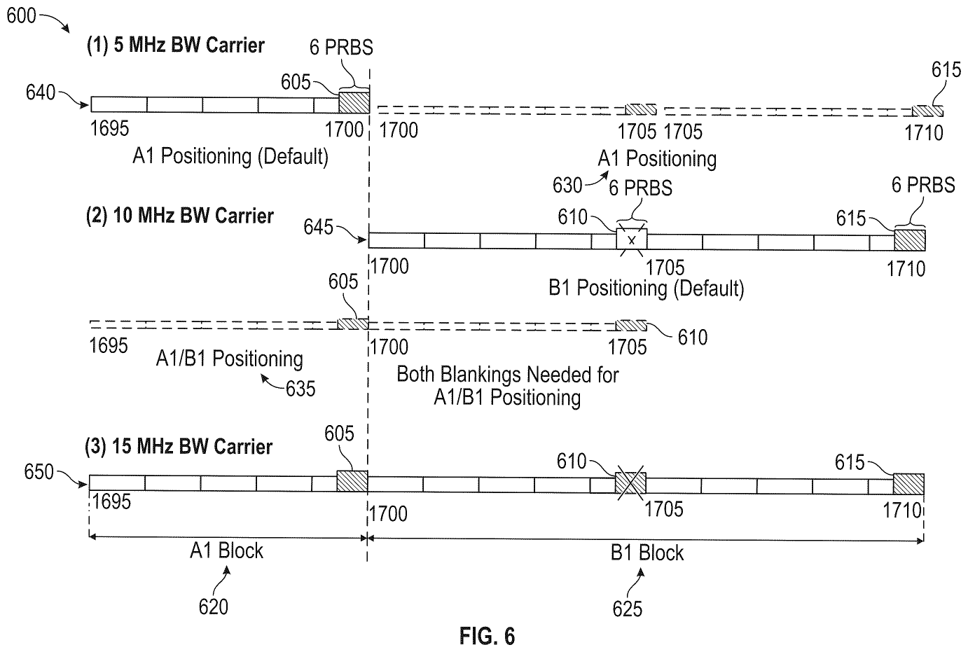

The example blanking pattern 600 shown in FIG. 6 is an implementation of the operationally efficient technique. It demonstrates how the single blanking pattern can be applied across different carrier bandwidths (5 MHz, 10 MHz, and 15 MHz) within the 5G NR UL frequency band.

FIG. 5 illustrates a power spectral density problem 500 solved by the partitioning of the UL carrier BW illustrated in FIG. 3 and FIG. 4, according to various embodiments described herein.

Shown is a power spectral density problem 500 that can arise in the absence of proper bandwidth partitioning. The 15 MHz UL carrier band 505 is intended for 5G NR UL operations. This broad spectrum is essential for high-speed and high-capacity communication. Spike 510 indicates a narrowband transmission over a 180 kHz bandwidth 210, which results in a significant increase in power spectral density by 19.2 dB. This 19.2 dB increase in power is due to the high concentration of power within the narrow 180 kHz bandwidth 210 used for NB-IoT UL operations. Such a high-power density being next to the broader 15 MHz UL band 505 can cause substantial interference with the broader 15 MHz UL band 505 intended for 5G NR UL operations. The interference occurs because the high-power narrowband signal can overwhelm adjacent frequencies within the 5G NR UL spectrum, leading to degraded performance and potential communication failures.

The partitioning mechanism illustrated in FIG. 3 and FIG. 4 that partitions uplink (UL) carrier BW 300 solves this interference problem by segregating the uplink (UL) carrier BW 300 into distinct segments for NB-IoT operations (blanking pattern 310) and 5G NR operations (portion 305). By allocating a specific blanking pattern 310 for NB-IoT operations, the system ensures that the high-power density signal is confined to this narrow segment. The 5G NR UL portion 305 of the UL carrier BW 300 is reserved for 5G NR UL operations, free from the interference caused by NB-IoT transmissions. This strategic partitioning effectively mitigates the interference issue by isolating the high-power NB-IoT signals, allowing both types of operations to coexist within the same overall UL carrier BW 300 without detrimental effects on each other. The result is a more efficient and reliable utilization of the available spectrum, supporting both high-capacity 5G NR services and the specific needs of NB-IoT communications.

FIG. 6 illustrates an example blanking pattern 600 shown which is an example implementation of the operationally efficient UL BW allocation technique. It demonstrates how the single blanking pattern can be applied across different carrier bandwidths (5 MHz, 10 MHz, and 15 MHz) within the 5G NR UL frequency band. In particular, FIG. 6 illustrates an example implementation of an NB-IoT specific blanking pattern 600 within the n70 unpaired spectrum, including the allocation and management of UL carrier BWs for various carrier configurations (5 MHz, 10 MHz, and 15 MHz) within the 5G NR UL frequency band, according to various embodiments described herein.

Implementation of the blanking pattern 600 facilitates the coexistence of NB-IoT and 5G NR operations while protecting critical frequencies, such as those used by NOAA. Shown is a representation of spectrum management for different bandwidth carriers (5 MHz, 10 MHz, and 15 MHz), demonstrating how specific portions of the UL carrier BW may be allocated under varying conditions.

In the 5 MHz bandwidth scenario, a 5 MHz UL carrier BW 640 spans from 1695 MHz to 1700 MHz, with a specific blanking pattern 605 for NB-IoT operations (e.g., consisting of six Physical Resource Blocks (PRBs)) positioned near the upper end of the bandwidth around the 1700 MHz mark. This configuration is referred to as A1 Positioning (Default) within A1 Block 620. In an example embodiment, the specific blanking pattern 605 for NB-IoT operations is selected to always be at an upper end of the 5 MHz UL carrier BW 640 allocated to the wireless carrier such that if a default position of the UL carrier BW allocated to the wireless carrier shifts by 5 MHz increments within the 5G NR UL frequency band (e.g., to another end of the 5G NR UL frequency band) the specific blanking pattern 605 for NB-IoT operations would still be outside the determined protection frequencies. For example, the alternate A1 Positioning 630, shown as dashed lines, indicates how the 5 MHz UL carrier BW 640 may be shifted by 5 MHz increments within the 5G NR UL frequency band to accommodate different operational requirements (with one example showing a shift to the 1700-1705 MHz band and another showing a shift to the 1705-1710 MHz band). In the example showing a shift to the 1705-1710 MHz band, with the specific blanking pattern for NB-IoT operations being selected to always be at an upper end of the 5 MHz UL carrier BW, the specific blanking pattern for NB-IoT operations 615 is shown at a position in the 5G NR UL frequency band still outside the determined NOAA protection frequencies.

In the 10 MHz bandwidth scenario, a 10 MHz UL carrier BW 645 extends from 1700 MHz to 1710 MHz. In the example embodiment, the specific blanking pattern for NB-IoT operations 615 (e.g., consisting of six PRBs) is
is allocated near 1710 MHz, depicted as B1 Positioning (Default) within B1 Block 625. The blanking pattern 610 for NB-IoT operations allocated at 1705 MHz is not needed for B1 Positioning (Default). However, this positioning highlights the system's flexibility to manage different bandwidth allocations dynamically. A1/B1 Positioning 635, also shown as dashed lines, illustrates how the carriers can be shifted, indicating the potential need for blanking patterns when both A1 and B1 positions are utilized. Specifically, A1/B1 Positioning 635 shows that both blanking pattern 605 at 1700 MHz and blanking pattern 610 at 1705 MHz are used for A1/B1 positioning, to protect the NOAA frequencies when required.

In the 15 MHz bandwidth scenario, a 15 MHz UL BW carrier 650 covers the entire frequency range from 1695 MHz to 1710 MHz. In the present example embodiment, blanking patterns for NB-IoT UL operations are allocated at two different positions including blanking pattern 605 near 1700 MHz (A1 positioning) within A1 Block 620 and around 1710 MHz (B1 positioning) within B1 Block 625, particularly to protect NOAA frequencies. The blanking pattern 610 for NB-IoT operations allocated at 1705 MHz is not needed for the 15 MHz UL BW carrier 650 scenario. By implementing these specific blanking patterns, the system ensures that NB-IoT transmissions occur outside the NOAA-protected frequencies, thereby avoiding interference and maintaining reliable communication for IoT devices.

In an example embodiment, the example blanking pattern 600 shown in FIG. 6 is outside of a determined superset of frequencies (i.e., outside the collection of the frequencies to be protected for all NOAA satellites regardless of time and location). The specific pattern shown in FIG. 6 (frequency band right edge allocation) has an additional benefit for the current NOAA satellites, which is one pattern fits all carrier positions, i.e., it works for the carriers positioned for 1695-1700 Mhz, 1700-1705 Mhz, and 1705-1710 Mhz without needing to define separate patterns for the latter 2 cases.

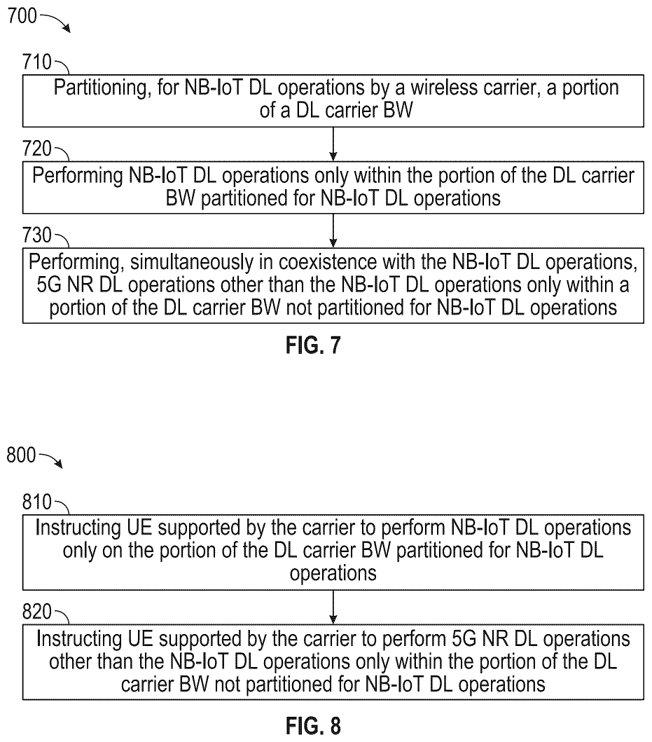

FIG. 7 is a flowchart illustrating a method 700 for managing DL operations within a wireless telecommunication system, according to various embodiments described herein.

At 710, the system partitions, for narrowband-Internet of Things (NB-IoT) downlink (DL) operations by a wireless carrier, a portion of a DL carrier bandwidth (BW) allocated to the carrier within a Fifth Generation (5G) New Radio (NR) DL frequency band.

At 720, the system performs NB-IoT DL operations only within the portion of the DL carrier BW partitioned for NB-IoT DL operations.

At 730, the system performs, simultaneously in coexistence with the NB-IoT DL operations, 5G NR DL operations other than the NB-IoT DL operations only within a portion of the DL carrier BW not partitioned for NB-IoT DL operations.

In an example embodiment, the DL carrier BW allocated to the wireless carrier is 25 MHz, the 5G NR DL frequency band has a DL frequency range from 1995-2020 MHz, the portion of the DL carrier BW partitioned for NB-IoT DL operations is 5 MHz and the portion of the DL carrier BW not partitioned for NB-IoT DL operations is 20 MHz. In an example embodiment, the 5G NR DL operations other than the NB-IoT DL operations include existing Enhanced Mobile Broadband (eMBB) DL operations.

FIG. 8 is a flowchart illustrating a method 800 for partitioning, for NB-IoT DL operations, a portion of the DL carrier BW useful in the method of FIG. 7, according to various embodiments described herein.

At 810, the system instructs UE supported by the carrier to perform NB-IoT DL operations only on the portion of the DL carrier BW partitioned for NB-IoT DL operations.

At 820, the system instructs UE supported by the carrier to perform 5G NR DL operations other than the NB-IoT DL operations only within the portion of the DL carrier BW not partitioned for NB-IoT DL operations.

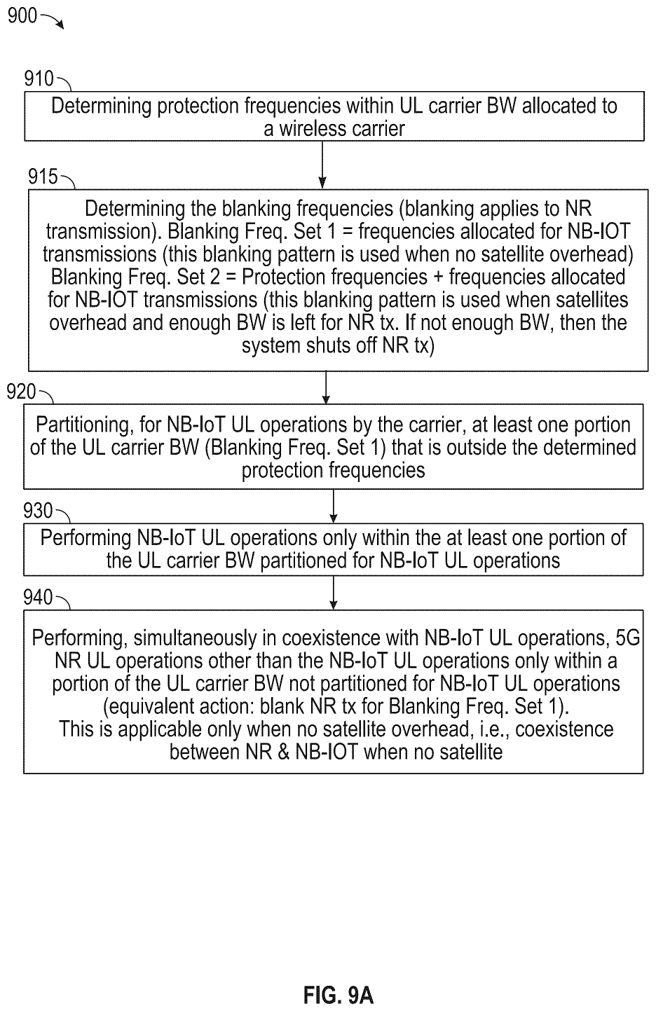

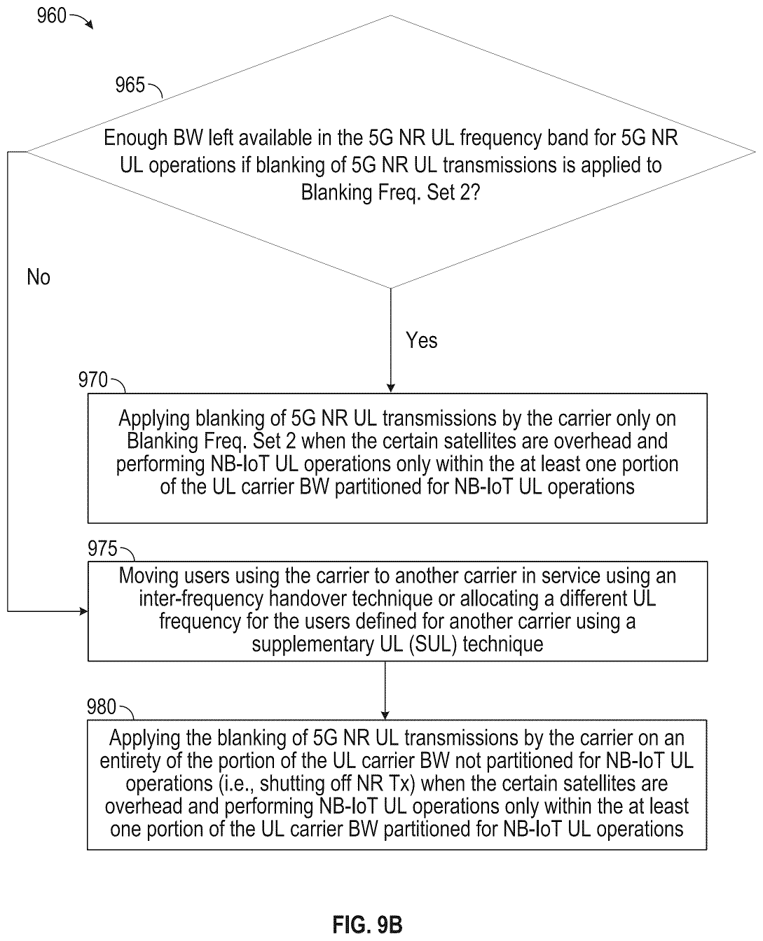

FIG. 9A is a flowchart illustrating a method 900 for managing UL operations within a wireless telecommunication system in an example baseline scheme for managing UL operations when no satellite is overhead, according to various embodiments described herein.

At 910, the system determines protection frequencies within an uplink (UL) carrier bandwidth (BW) allocated to a wireless carrier within a Fifth Generation (5G) New Radio (NR) UL frequency band, wherein the protection frequencies are frequencies to be protected from UL transmissions by the carrier in the 5G NR UL frequency band at times when certain satellites are overhead.

At 915, the system determines the blanking frequencies. The blanking applies to NR transmission. In an example embodiment, Blanking Frequency Set 1 is frequencies allocated for NB-IOT transmissions. This blanking pattern is used when no satellite is overhead. Blanking Frequency Set 2 is the protection frequencies plus frequencies allocated for NB-IOT transmissions. This blanking pattern is used when satellites are overhead, and enough BW is left for NR transmission (tx). If there is not enough BW, then the system shuts off NR tx.

At 920, the system, partitions, for narrowband-Internet of Things (NB-IoT) UL operations by the carrier, at least one portion of the UL carrier BW (Blanking Frequency Set 1) that is outside the determined protection frequencies.

At 930, the system performs NB-IoT UL operations only within the at least one portion of the UL carrier BW partitioned for NB-IoT UL operations.

At 940, the system performs, simultaneously in coexistence with NB-IoT UL operations, 5G NR UL operations other than the NB-IoT UL operations only within a portion of the UL carrier BW not partitioned for NB-IoT UL operations. An equivalent action is blank NR tx for Blanking Frequency Set 1.

This is applicable only when no satellite is overhead, i.e., there is coexistence between NR & NB-IOT when no satellite is overhead.

In an example embodiment, the protection frequencies for the certain satellites have geo-location and time dependency, i.e., given time and location, the frequencies to be protected depend on which satellites are overhead. This creates a large complexity in operation, since each Next Generation Node B (“gNodeB” or “gNB”) must maintain multiple banking patterns to accommodate such geo-location and time dependency parameters. These patterns are different for different gNBs. This provides a motivation for implementing the option disclosed in method 900 in which only one set of blanking frequencies is defined for the entire operation irrespective of time and location. The NB-IOT UL transmission for the NB-IoT UL operations is allocated here. When the certain satellites are not overhead, 5G NR and NB-IOT coexist with this partitioning scheme. When the certain satellites are overhead, 5G NR blanks the entire UL, hence only satellite and NB-IOT UL transmission is allowed during this time.

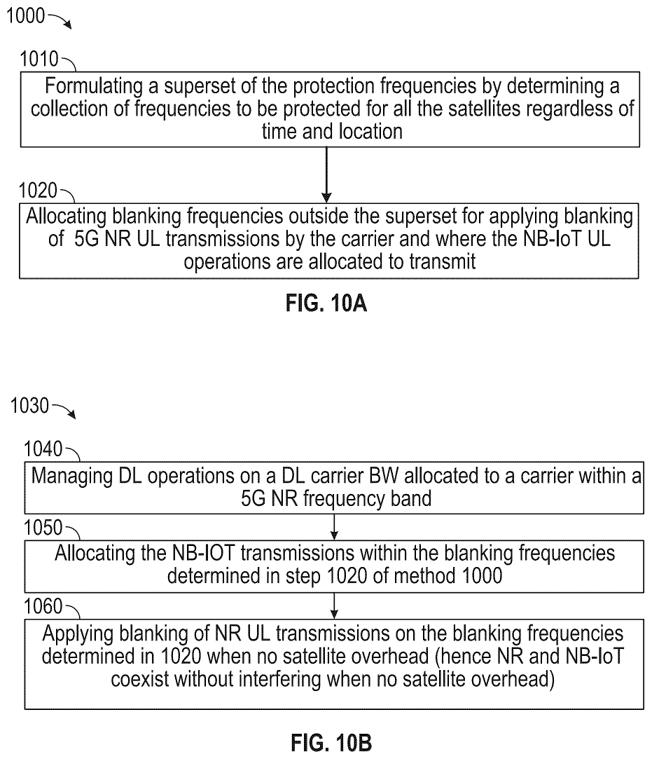

In an example embodiment, determination of the blanking frequencies in method 900 may include formulating the superset of the protection frequencies (i.e., collection of the frequencies to be protected for all satellites regardless of time and location) and allocating the blanking frequencies outside of this superset. This is where NB-IOT UL is allocated to transmit. An example of this process is method 100 shown in FIG. 10B.

In an example embodiment, the example blanking pattern 600 shown in FIG. 6 is outside of the superset for the existing NOAA satellites. The specific pattern shown in FIG. 6 (frequency band right edge allocation) has an additional benefit for the current NOAA satellites, which is one pattern fits all carrier positions, i.e., it works for the carriers positioned for 1695-1700 Mhz, 1700-1705 Mhz, and 1705-1710 Mhz without needing to define separate patterns for the latter 2 cases.

In an example embodiment, the UL carrier BW allocated to the wireless carrier is 5 MHz, 10 MHz or 15 MHz and the 5G NR UL frequency band has a UL frequency range from 1695-1710 MHz. In an example embodiment, the UL carrier BW allocated to the wireless carrier is 5 MHz or 10 MHz and the at least one portion of the UL carrier BW partitioned for NB-IoT UL operations consists of one portion of the UL carrier BW partitioned for NB-IoT UL operations that has a 1080 kHz BW or a 2160 kHz BW. In such an embodiment, the one portion of the UL carrier BW partitioned for NB-IoT UL operations is selected to always be at an upper end of the UL carrier BW allocated to the wireless carrier such that if a default position of the UL carrier BW allocated to the wireless carrier shifts by 5 MHz increments within the 5G NR UL frequency band, the one portion of the UL carrier BW partitioned for NB-IoT UL operations would still be outside the determined protection frequencies.

In an example embodiment, the UL carrier BW allocated to the wireless carrier is 15 MHz and the at least one portion of the UL carrier BW partitioned for NB-IoT UL operations consists of a first portion that has a 1080 kHz BW or a 2160 kHz BW with an upper end of 1700 MHz and a second portion that has a 1080 kHz BW or a 2160 kHz BW with an upper end of 1710 MHz.

In an example embodiment, the partitioning, for NB-IoT DL operations, at least a portion of the UL carrier BW includes instructing user equipment (UE) supported by the carrier to perform NB-IoT UL operations only on the at least one portion of the UL carrier BW partitioned for NB-IoT DL operations. The system also instructs UE supported by the carrier to perform 5G NR UL operations other than the NB-IoT UL operations only within the portion of the UL carrier BW not partitioned for NB-IoT UL operations.

In an example embodiment, there are two options provided when the certain satellites are overhead. The first option is for the system to blank 5G NR UL transmission for the protection frequencies for the satellites and the frequencies allocated for the NB-IOT UL transmission (note these two frequency sets are disjoint). This can be performed if enough BW is available for 5G NR transmission after the blanking frequencies are determined. In an example embodiment, an absolute minimum for there to be enough BW available for 5G NR transmission is that there is enough BW to accommodate the UL control channels). In this case, 5G NR is transmitted outside of the blanking zones. Hence, when utilizing this option simultaneous UL transmissions (for satellites, 5G NR, NB-IOT) are allowed.

If there is not enough BW available for UL transmission, the second option is for the system to blank the entire UL transmission, i.e., only satellites and NB-IOT are transmitted during this period. In order to maintain service continuity for 5G NR users utilizing the second option, the system may make available two options that it can perform. One option is to move the users using the particular carrier to another carrier in service (e.g., n66) before blanking is applied. For example, this can be performed using an inter-frequency handover technique.

Another option is, while using the same DL frequency for those users, allocate the different UL frequency (i.e., a UL frequency defined for the other carrier). For example, a DL frequency may be used for n70, but an UL frequency may be used for n66. This may be performed using a supplementary UL (SUL) technique. FIG. 9B provides a high-level illustration of a method implementing the options described above.

In particular, FIG. 9B is a flowchart illustrating a method 960 for managing UL operations within a wireless telecommunication system wherein different options may be utilized depending on whether there is enough BW left available in the 5G NR UL frequency band for 5G NR UL operations if blanking of 5G NR UL transmissions is applied in the determined protection frequencies, such as in an example baseline scheme for managing UL operations when one or more satellites are overhead, according to various embodiments described herein. In an example embodiment, method 960 is performed using the blanking frequencies determined in method 900 of FIG. 9A. For example, the method 960 may be an example implementation of the baseline scheme for managing UL operations when there is one or more satellites overhead.

At 965, the system determines whether there is enough BW left available in the 5G NR UL frequency band for 5G NR UL operations if blanking of 5G NR UL transmissions is applied to Blanking Frequency Set 2. If it is determined there is enough BW left available in the 5G NR UL frequency band for 5G NR UL operations if blanking of 5G NR UL transmissions is applied to Blanking Frequency Set 2, then the method 960 proceeds to 970. If it is determined there is not enough is enough BW left available in the 5G NR UL frequency band for 5G NR UL operations if blanking of 5G NR UL transmissions is applied to Blanking Frequency Set 2, then the method 960 proceeds to 975.

At 970, the system has determined there is enough is enough BW left available in the 5G NR UL frequency band for 5G NR UL operations if blanking of 5G NR UL transmissions is applied to Blanking Frequency Set 2, and thus the system applies blanking of 5G NR UL transmissions by the carrier only on Blanking Frequency Set 2 when the certain satellites are overhead and performs NB-IoT UL operations only within the at least one portion of the UL carrier BW partitioned for NB-IoT UL operations, thereby enabling three simultaneous UL transmissions including transmission of the certain satellites, 5G NR UL transmissions and NB-IoT UL.

At 975, the system has determined there is not enough BW left available in the 5G NR UL frequency band for 5G NR UL operations if blanking of 5G NR UL transmissions is applied, and thus the system first moves users using the carrier to another carrier in service using an inter-frequency handover technique or allocates a different UL frequency for the users defined for another carrier using a supplementary UL (SUL) technique.

At 980, after moving the users or allocating the different UL frequency, the system applies the blanking of 5G NR UL transmissions by the carrier on an entirety of the portion of the UL carrier BW not partitioned for NB-IoT UL operations (i.e., shuts off NR Tx) when the certain satellites are overhead and performs NB-IoT UL operations only within the at least one portion of the UL carrier BW partitioned for NB-IoT UL operations.

Thus, in various embodiments of the baseline scheme, different options may be utilized depending on whether there is enough BW left available in the 5G NR UL frequency band for 5G NR UL operations if blanking of 5G NR UL transmissions is applied in the determined protection frequencies. In such embodiments, the system manages DL operations on a DL carrier BW allocated to a carrier within a 5G NR frequency band. For example, these may include the operations of method 700 of FIG. 7. In addition, the system may determine as described above whether there is enough BW left available in the 5G NR UL frequency band for 5G NR UL operations if blanking of 5G NR UL transmissions is applied in the determined protection frequencies. In instances where it is determined there is enough BW left available in the 5G NR UL frequency band for 5G NR UL operations if blanking of 5G NR UL transmissions is applied in the determined protection frequencies, the system may apply blanking of 5G NR UL transmissions by the carrier only on the determined protection frequences when the certain satellites are overhead, thereby enabling three simultaneous UL transmissions including transmission of the certain satellites, 5G NR UL transmissions and NB-IoT UL.

In instances where it is determined there is not enough BW left available in the 5G NR UL frequency band for 5G NR UL operations if UL blanking is applied in the determined protection frequencies, the system may move users using the carrier to another carrier in service using an inter-frequency handover technique or allocating a different UL frequency for the users defined for another carrier using a supplementary UL (SUL) technique. After moving the users or allocating the different UL frequency, the system may apply the blanking of 5G NR UL transmissions by the carrier on an entirety of the portion of the UL carrier BW not partitioned for NB-IoT UL operations when the certain satellites are overhead.

FIG. 10A is a flowchart illustrating a method 1000 for implementing a preparation stage in determining the banking frequencies for an operationally efficient scheme for managing UL operations, according to various embodiments described herein.

At 1010, the system formulates a superset of the protection frequencies by determining a collection of frequencies to be protected for all the satellites regardless of time and location.

At 1020, the system allocates blanking frequencies outside the superset for applying blanking of 5G NR UL transmissions by the carrier and where the NB-IoT UL operations are allocated to transmit.

FIG. 10B is a flowchart illustrating a method 1030 for managing UL and DL operations within a wireless telecommunication system in an example implementation of the operationally efficient scheme for managing UL operations when no satellite is overhead and applying the blanking pattern determined in method 1000 of FIG. 10A, according to various embodiments described herein.

At 1040 the system manages DL operations on a DL carrier BW allocated to a carrier within a 5G NR frequency band. For example, these may include the operations of method 700 of FIG. 7.

At 1050, the system allocates the NB-IoT transmissions within the blanking frequencies determined in step 1020 of method 1000 of FIG. 10A.

At 1060, the system applies blanking of NR UL transmissions on the blanking frequencies determined in step 1020 of method 1000 of FIG. 10A when no satellite is overhead (hence NR and NB-IoT coexist without interfering when no satellite overhead). In an example embodiment, the gNB applies the blanking pattern determined in method 1000 of FIG. 10A to its UL transmissions. NB-IoT transmissions are allocated inside of the blanking frequencies determined in method 1000 of FIG. 10A. Hence, NR UL transmissions and NB-IoT UL transmissions coexist.

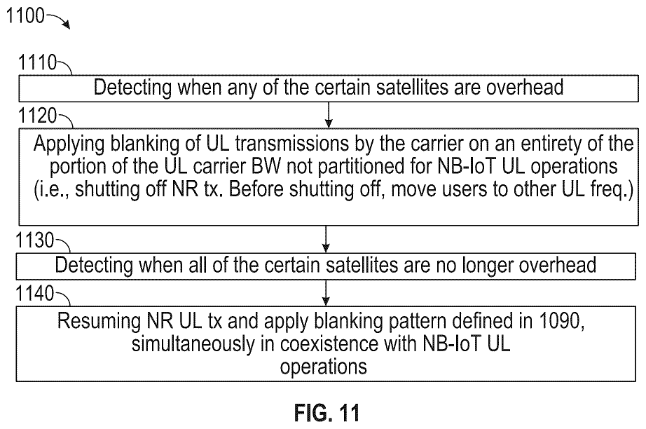

FIG. 11 is a flowchart illustrating a method 1100 for applying blanking of UL transmissions when the certain satellites are overhead useful in the operationally efficient scheme, according to various embodiments described herein.

At 1110, the system detects when any of the certain satellites are overhead. For example, this may be performed by various techniques, including, but not limited to satellite tracking and detecting the presence of satellite signals. Satellite tracking involves real-time tracking of satellite positions to identify when they are overhead or within a certain range. Terrestrial networks can use this information to implement protective measures like frequency shifting or power reduction. Terrestrial systems may detect the presence of satellite signals. This involves monitoring the spectrum and identifying when protected frequencies are in use by satellites.

At 1120, the system, in response to detecting that any of the certain satellites are overhead, applies blanking of UL transmissions by the carrier on an entirety of the portion of the UL carrier BW not partitioned for NB-IoT UL operations (i.e., shuts off NR tx). Before shutting off NR tx, the system moves users to another UL frequency.

At 1130, the system detects when all of the certain satellites are no longer overhead.

At 1140, the system, in response to detecting that all of the certain satellites are no longer overhead, resumes NR UL tx and applies the blanking pattern defined in operation 1090 of method 1070, simultaneously in coexistence with NB-IoT UL operations. In an example embodiment, the gNB shuts off the UL transmissions. In such instances, the gNB needs to move the UEs to another frequency band (i.e., inter-frequency handover), or allocate a UL frequency belonging to other frequency band (supplementary UL) before shutting off the UL transmissions.

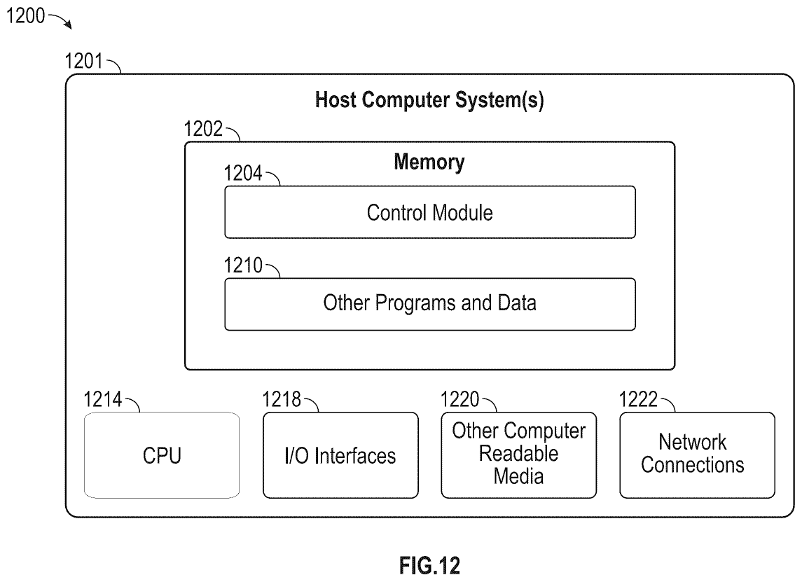

FIG. 12 shows a system diagram that describes an example implementation of computing system(s) 1200 for implementing embodiments described herein.

The functionality described herein for systems and methods for managing DL and UL operations within a wireless telecommunication system can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they're agnostic to the underlying cloud infrastructure, allowing higher deployment agility and flexibility. However, FIG. 12 illustrates an example of underlying hardware on which such software and functionality may be hosted and/or implemented.

In particular, shown is example host computer system(s) 1201. For example, such computer system(s) 1201 may represent one or more of those in base stations, telecommunication devices, various data centers and/or servers that are components of, or that host or implement the functions of, aspects described herein to implement systems and methods for managing DL and UL operations within a wireless telecommunication system. In some embodiments, one or more special-purpose computing systems may be used to implement the functionality described herein. Accordingly, various embodiments described herein may be implemented in software, hardware, firmware, or in some combination thereof. Host computer system(s) 1201 may include memory 1202, one or more central processing units (CPUs) 1214, I/O interfaces 1218, other computer-readable media 1220, and network connections 1222.

Memory 1202 may include one or more various types of non-volatile and/or volatile storage technologies. Examples of memory 1202 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1202 may be utilized to store information, including computer-readable instructions that are utilized by CPU 1214 to perform actions, including those of embodiments described herein.

Memory 1202 may have stored thereon control module(s) 1204. The control module(s) 1204 may be configured to implement and/or perform some or all of the functions of the systems, components and modules described herein to implement systems and methods for managing DL and UL operations within a wireless telecommunication system. Memory 1202 may also store other programs and data 1210, which may include rules, databases, application programming interfaces (APIs), software containers, nodes, pods, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc. In an example embodiment, the memory 1202 may be non-transitory computer-readable storage medium (meaning it is not a signal being transmitted that carries information). This storage medium may store computer-executable instructions. Then these instructions may be executed by at least one processor (e.g., CPUs 1214). The execution of these instructions causes the processor to perform various operations, including operations that implement the functionality described herein.

Network connections 1222 are configured to communicate with other computing devices to facilitate the functionality described herein. In various embodiments, the network connections 1222 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1218 may include transmitter interfaces, receiver interfaces, transceiver interfaces, other data input or output interfaces, or the like. Other computer-readable media 1220 may include other types of stationary or removable computer-readable media, such as removable flash drives, external hard drives, or the like. In various embodiments, the particular order of the operations described herein may be rearranged; some operations may be performed in parallel; shown operations may be omitted, or other operations may be included; a shown operation may be divided into one or more component operations, or multiple shown operations may be combined into a single operation, etc.

The various embodiments described above can be combined to provide further embodiments. Aspects of the embodiments can be modified, if necessary to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a wireless telecommunication system, the method comprising:
partitioning, for narrowband-Internet of Things (NB-IoT) downlink (DL) operations by a wireless carrier, a portion of a DL carrier bandwidth (BW) allocated to the carrier within a Fifth Generation (5G) New Radio (NR) DL frequency band;
performing NB-IoT DL operations only within the portion of the DL carrier BW partitioned for NB-IoT DL operations; and
performing, simultaneously in coexistence with the NB-IoT DL operations, 5G NR DL operations other than the NB-IoT DL operations only within a portion of the DL carrier BW not partitioned for NB-IoT DL operations.

2. The method of claim 1 wherein the DL carrier BW allocated to the wireless carrier is 25 MHz and the 5G NR DL frequency band has a DL frequency range from 1995-2020 MHz.

3. The method of claim 2 wherein the portion of the DL carrier BW partitioned for NB-IoT DL operations is 5 MHz.

4. The method of claim 3 wherein the portion of the DL carrier BW not partitioned for NB-IoT DL operations is 20 MHz.

5. The method of claim 4 wherein the 5G NR DL operations other than the NB-IoT DL operations include existing Enhanced Mobile Broadband (eMBB) DL operations.

6. The method of claim 1 wherein the partitioning, for NB-IoT DL operations, a portion of the DL carrier BW includes:
instructing user equipment (UE) supported by the carrier to perform NB-IoT DL operations only on the portion of the DL carrier BW partitioned for NB-IoT DL operations; and
instructing UE supported by the carrier to perform 5G NR DL operations other than the NB-IoT DL operations only within the portion of the DL carrier BW not partitioned for NB-IoT DL operations.

7. The method of claim 1, further comprising:
determining protection frequencies within an uplink (UL) carrier BW allocated to the carrier within a 5G NR UL frequency band, wherein the protection frequencies are frequencies to be protected from UL transmissions by the carrier in the 5G NR UL frequency band at times when certain satellites are overhead;
partitioning, for NB-IoT UL operations by the carrier, at least one portion of the UL carrier BW that is outside the determined protection frequencies;
performing NB-IoT UL operations only within the at least one portion of the UL carrier BW partitioned for NB-IoT UL operations;
performing, simultaneously in coexistence with NB-IoT UL operations, 5G NR UL operations other than the NB-IoT UL operations only within a portion of the UL carrier BW not partitioned for NB-IoT UL operations; and
applying blanking of UL transmissions by the carrier on an entirety of the portion of the UL carrier BW not partitioned for NB-IoT UL operations when the certain satellites are overhead.

8. The method of claim 7, further comprising:
determining whether there is enough BW left available in the 5G NR UL frequency band for 5G NR UL operations if blanking of 5G NR UL transmissions is applied in the determined protection frequencies;
in instances where it is determined there is enough BW left available in the 5G NR UL frequency band for 5G NR UL operations if blanking of 5G NR UL transmissions is applied in the determined protection frequencies, applying blanking of 5G NR UL transmissions by the carrier only on the determined protection frequences when the certain satellites are overhead, thereby enabling three simultaneous UL transmissions including transmission of the certain satellites, 5G NR UL transmissions and NB-IoT UL; and
applying the blanking of 5G NR UL transmissions by the carrier on an entirety of the portion of the UL carrier BW not partitioned for NB-IoT UL operations when the certain satellites are overhead only in instances where it is determined there is not enough BW left available in the 5G NR UL frequency band for 5G NR UL operations if UL blanking is applied in the determined protection frequencies.

9. A system comprising:
at least one computer processor; and
at least one non-transitory memory device coupled to the at least one processor, the at least one non-transitory memory device having computer-executable instructions stored thereon which, when executed by the at least one computer processor, cause operations to be performed, the operations including:
partitioning, for narrowband-Internet of Things (NB-IoT) downlink (DL) operations by a wireless carrier, a portion of a DL carrier bandwidth (BW) allocated to the carrier within a Fifth Generation (5G) New Radio (NR) DL frequency band;
performing NB-IoT DL operations only within the portion of the DL carrier BW partitioned for NB-IoT DL operations; and
performing, simultaneously in coexistence with the NB-IoT DL operations, 5G NR DL operations other than the NB-IoT DL operations only within a portion of the DL carrier BW not partitioned for NB-IoT DL operations.

10. The system of claim 9 wherein the DL carrier BW allocated to the wireless carrier is 25 MHz.

11. The system of claim 10 wherein the 5G NR DL frequency band has a DL frequency range from 1995-2020 MHz.

12. The system of claim 11 wherein the portion of the DL carrier BW partitioned for NB-IoT DL operations is 5 MHz.

13. The system of claim 12 wherein the portion of the DL carrier BW not partitioned for NB-IoT DL operations is 20 MHz.

14. The system of claim 13 wherein the 5G NR DL operations other than the NB-IoT DL operations include existing Enhanced Mobile Broadband (eMBB) DL operations.

15. The system of claim 9 wherein the partitioning, for NB-IoT DL operations, a portion of the DL carrier BW includes:
instructing user equipment (UE) supported by the carrier to perform NB-IoT DL operations only on the portion of the DL carrier BW partitioned for NB-IoT DL operations; and
instructing UE supported by the carrier to perform 5G NR DL operations other than the NB-IoT DL operations only within the portion of the DL carrier BW not partitioned for NB-IoT DL operations.

16. The system of claim 9, wherein the operations further comprise:
determining protection frequencies within an uplink (UL) carrier BW allocated to the carrier within a 5G NR UL frequency band, wherein the protection frequencies are frequencies to be protected from UL transmissions by the carrier in the 5G NR UL frequency band at times when certain satellites are overhead;
partitioning, for NB-IoT UL operations by the carrier, at least one portion of the UL carrier BW that is outside the determined protection frequencies;
performing NB-IoT UL operations only within the at least one portion of the UL carrier BW partitioned for NB-IoT UL operations;
performing, simultaneously in coexistence with NB-IoT UL operations, 5G NR UL operations other than the NB-IoT UL operations only within a portion of the UL carrier BW not partitioned for NB-IoT UL operations; and
applying blanking of UL transmissions by the carrier on an entirety of the portion of the UL carrier BW not partitioned for NB-IoT UL operations when the certain satellites are overhead.

17. A computer-readable medium having computer-executable instructions stored thereon which, when executed by at least one processor, cause the at least one processor to perform operations, the operations including:
partitioning, for narrowband-Internet of Things (NB-IoT) downlink (DL) operations by a wireless carrier, a portion of a DL carrier bandwidth (BW) allocated to the carrier within a Fifth Generation (5G) New Radio (NR) DL frequency band;
performing NB-IoT DL operations only within the portion of the DL carrier BW partitioned for NB-IoT DL operations; and
performing, simultaneously in coexistence with the NB-IoT DL operations, 5G NR DL operations other than the NB-IoT DL operations only within a portion of the DL carrier BW not partitioned for NB-IoT DL operations.

18. The computer-readable medium of claim 17 wherein the DL carrier BW allocated to the wireless carrier is 25 MHz.

19. The computer-readable medium of claim 18 wherein the 5G NR DL frequency band has a DL frequency range from 1995-2020 MHz.

20. The computer-readable medium of claim 19 wherein the portion of the DL carrier BW partitioned for NB-IoT DL operations is 5 MHz.
